(19) United States
(12) Patent Application Publication
(10) Pub. No.: US 2004/0034702 A1
(43) Pub. Date: Feb. 19, 2004

(54) Method and apparatus for exchanging intra-domain routing information between VPN sites

(75) Inventor: Haixiang He, Woburn, MA (US)

Correspondence Address: JOHN C. GORECKI, ESQ., 165 HARVARD ST., NEWTON, MA, 02460, US

(73) Assignee: Nortel Networks Limited, St. Laurent (CA)

(21) Appl. No.: 10/222,059

(22) Filed: Aug. 16, 2002

(51) Int. Cl. G06F 15/173

(52) U.S. Cl. 709/224; 709/238

(57) ABSTRACT

Intra-domain routing information may be exchanged between multiple VPN sites on a VPN by establishing a network device as a BGP router reflector and establishing BGP peering sessions between each VPN site and the BGP router reflector. The BGP router reflector is configured to collect intra-domain routing information from customer edge network devices on the VPN sites, and exchange routing information with the other customer edge devices on the VPN. Thus, routing information may be sent from one site to all other sites on the VPN with a single BGP peering session. This reduces the number of BGP peering sessions on the network and, hence, the resources required to exchange the routing information. Additionally, the BGP router reflector can maintain a more complete view of the VPN tunnels to route traffic around inoperable or malfunctioning VPN tunnels to thereby improve resiliency of the network.

### BACKGROUND OF THE INVENTION

1. Field of the Invention

The present invention relates to communication networks and, more particularly, to a method and apparatus for exchanging reachability information between autonomous networks.

2. Description of the Related Art

Data communication networks may include various computers, servers, nodes, routers, switches, hubs, proxies, and other devices coupled to and configured to pass data to one another. These devices will be referred to herein as “network devices.” Data is communicated through the data communication network by passing data packets (or data cells or segments) between the network devices by utilizing one or more communication links. A particular packet may be handled by multiple network devices and cross multiple communication links as it travels between its source and its destination over the network.

The various network devices on the communication network communicate with each other using predefined sets of rules, referred to herein as protocols. Different protocols are used to govern different aspects of the communication, such as how signals should be formed for transmission between network devices, various aspects of what the data packets should look like, and how packets should be handled or routed through the network by the network devices.

A Virtual Private Network may be formed by connecting two or more networks or network devices over a public network using encryption or other means, such as by attaching a unique label to traffic in a Multiprotocol Label Switching (MPLS) network, to secure the transmissions between the two or more networks or network devices. Using VPN tunnels over a public network such as the Internet enables a network having geographically separated components to be set up as a single autonomous network without requiring the network participants to lease dedicated lines through the network. As used herein, the term “autonomous network” will be used to refer to a network or group of networks under a common administration and with common routing policies. The term “VPN site” will be used to refer to a network or portion of a network that is to be connected to a VPN tunnel. VPN sites situated on opposite ends of a VPN tunnel may be autonomous networks, parts of different autonomous networks, or parts of the same autonomous network. The network connectivity service provider, such as an Internet service provider (ISP), may provide services to facilitate establishment of VPN tunnels over the network. For example, the connectivity provider may configure the customer edge network devices in such a way that the customers may transparently run routing protocols to configure static routes through the VPN tunnels. Additionally, the ISP may manage distribution of inter-site reachability information. In a provider provisioned VPN network scenario, such as the network illustrated in FIG. 1 (discussed in greater detail below), the connectivity provider will typically employ a router server 30 which may be used, at least in part, to set up the customer edge network devices, to establish VPN tunnels between the network devices, and to distribute inter-site reachability information.

Routing within an autonomous network (intra-site reachability information) is typically handled by the VPN customer. An autonomous network, such as may be used by a university or corporation, will generally employ an Interior Gateway Protocol (IGP) such as RIP (Routing Information Protocol), OSPF (Open Shortest Path First), or Interior Border Gateway Protocol (IBGP) to exchange routing information between network devices within the autonomous network.

To enable devices on one VPN site to communicate with devices on another VPN site via the VPN tunnel, it is necessary to exchange routing information between the two VPN sites. Likewise, as network devices are added and removed from the networks, or as problems are encountered and fixed in the networks, the routing tables need to be updated and advertised to the other participating sites in the VPN. This may be accomplished in a variety of ways, such as by running OSPF or RIP through the tunnel. Another way this may be accomplished is to treat each VPN site as an autonomous network, and to exchange routing information between the VPN sites using a protocol designed to exchange routing information between autonomous networks, such as Border Gateway Protocol (BGP).

FIG. 1 illustrates a conventional network utilizing three VPN tunnels between three VPN sites. As shown in FIG. 1, customer edge network devices 12, 14, 16 on respective VPN sites 18, 20, 22 will collect routing information from within their respective VPN sites and advertise that routing information to the customer edge network devices on other participating VPN sites in the virtual private network 10 using one-on-one BGP peering sessions. While this works in a simplified network, such as the network illustrated in FIG. 1, as networks develop and hundreds of VPN sites with hundreds or thousands of virtual private network tunnels are used, establishing and maintaining hundreds or thousands of individual BGP sessions becomes resource intensive.

Moreover, establishing a BGP session with another VPN site, while allowing routing information to be exchanged between the two particular VPN sites, does not allow network information or routing information to be exchanged at the global network level. Thus, for example, if the tunnel 24 between customer edge network device CE2 (14) and customer edge network device CE3 (16) is down, CE2 (14) will not know that it can get packets to CE3 (16) by first passing them over tunnel 26 to CE1 (12) and then having the packets forwarded onward via tunnel 28 from CE1 (12) to CE3 (16). Accordingly, it would be advantageous to facilitate distribution of intra-site reachability information in an efficient manner, and in a way that would enable a global network view to be established.

### SUMMARY OF THE INVENTION

The present invention overcomes these and other drawbacks by providing an apparatus and method for exchanging routing information between VPN sites by configuring a computer or network device as a BGP router reflector. The BGP router reflector may be configured as part of the router server, as an independent computer or network device, or as a sub-system on another computer or network device. According to one embodiment of the invention, customer edge devices participating in the virtual private network each establish a BGP peering session with the BGP router reflector. The BGP router reflector is configured to collect intra-domain network routing information from the customer edge network devices, and exchange routing information with the other customer edge devices on the virtual private network. By configuring the BGP router reflector in this manner, the customer edge network devices may advertise routing information to all relevant customer edge devices via a single BGP peering session. This reduces the number of BGP peering sessions on the network and, hence, the resource cost associated with exchanging intra-domain network routing information. Additionally, the BGP router reflector can maintain a network level view of the virtual private network tunnels to enable other established virtual private network tunnels to be used to route around inoperable or malfunctioning virtual private network tunnels to improve resiliency of the network.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a conventional network employing virtual private network tunnels between VPN sites;

FIG. 2 is a functional block diagram of a network including a BGP router reflector according to an embodiment of the invention;

FIG. 3 is a flow-chart of a method for exchanging intra-domain reachability information according to an embodiment of the invention;

FIG. 4 is a functional block diagram of a BGP router reflector according to an embodiment of the invention; and

FIG. 5 is a functional block diagram of a customer edge network device according to an embodiment of the invention.

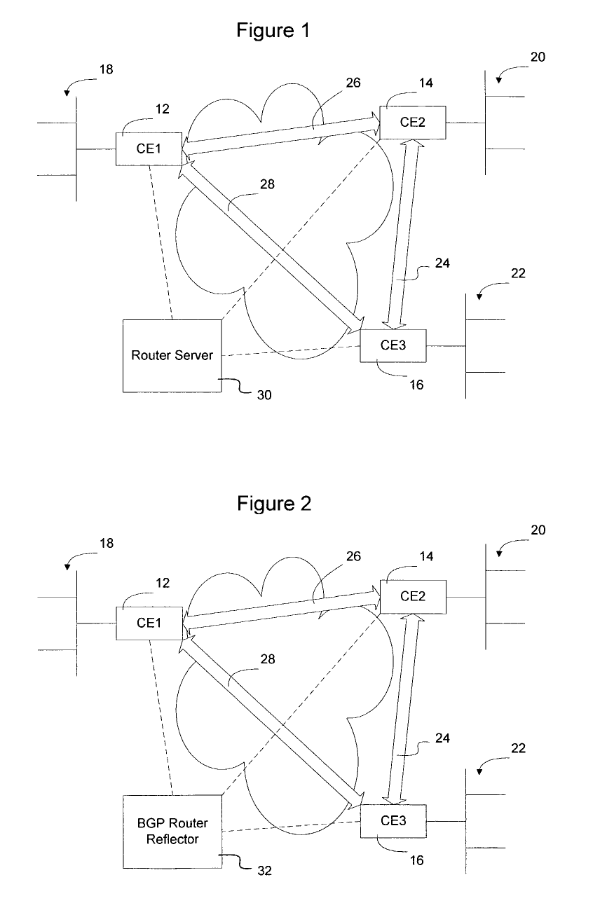

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in greater detail below, the method and apparatus of the present invention configures a computer or network device as a BGP router reflector. The BGP router reflector may be used by all or a selected subset of VPN sites participating in the virtual private network to exchange intra-domain network reachability information without requiring each VPN site to set up an individual BGP peering session with each other VPN site. This enables an efficient exchange of intra-domain network routing information to take place. In addition, the BGP router reflector may be used to establish a global network routing view to increase resiliency in the network.

One example of a network employing virtual private network (VPN) tunnels to interconnect VPN sites is illustrated in FIG. 2. As shown in FIG. 2, VPN tunnels may be used to interconnect two or more VPN sites across a public network, such as the Internet, using any conventional means. In the example illustrated in FIG. 2, three customer edge network devices 12, 14, 16, are interconnected via virtual private network tunnels 24, 26, 28. The VPN tunnels may be any type of tunnel, such as a VPN tunnel formed via encapsulation on a MPLS network, or any other type of tunnel formed by encapsulation, encryption, or via some alternative means. While this invention will be described as using VPN tunnels over the Internet, it should be apparent that the invention is not limited to VPN tunnels or to transmission over the Internet, but rather extends to other types of virtual circuits formed over any type of communications network. Likewise, while three CE network devices are illustrated in this network as being interconnected via three VPN tunnels, the invention is not limited to a network of this topography, as any number of CE network devices and VPN tunnels may be employed. Additionally, while the invention will be described as interconnecting VPN sites, the invention is not limited in this manner but rather extends to connecting any type of network desiring to participate in exchanging routing information with one or more other networks.

A BGP router reflector 32 is provided to host BGP peering sessions with all or a selected subset of the Customer Edge network devices, to collect routing information, and to forward that routing information on to other CE network devices designated as having a need to receive the routing information. The BGP router reflector may be located at any convenient location on the network. In one embodiment, the BGP router reflector is housed in the network device forming the router server and is owned and operated by the connectivity service provider. The invention is not limited in this manner, however, as the BGP router reflector may be situated in an independent computer or network device hosted by one of the VPN sites, the connectivity provider, or an independent third party, or may be included as a process running on another computer or network device forming part of the data communications network or the virtual private network.

In the embodiment illustrated in FIG. 2, the BGP router reflector is illustrated as connecting only with customer edge network devices that are part of the same virtual private network. The BGP router reflector, may, however, work with multiple VPN networks and communicate with customer edge network devices belonging, for example, to different companies or to different end users. The invention is not limited to a BGP router reflector communicating with a single set of VPN sites. Thus, for example, the BGP router reflector illustrated in FIG. 2 may additionally be configured to coordinate the exchange of intra-domain network routing information for other sets of CE network devices (not shown) that are not connected via tunnels to the illustrated CE network devices.

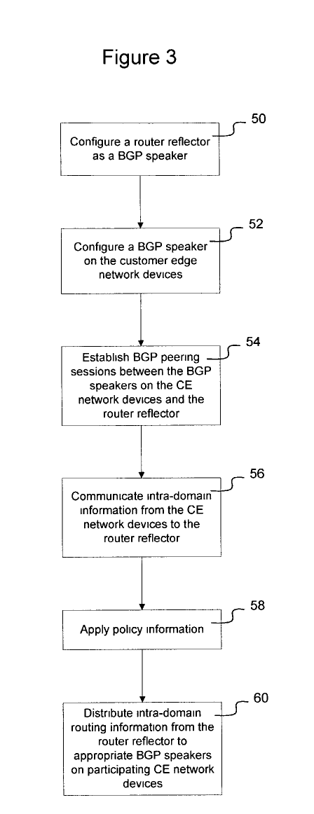

FIG. 3 illustrates a flow-chart of a method for exchanging intra-domain reachability information according to an embodiment of the invention. As illustrated in FIG. 3, initially, a router reflector is configured in the network as a BGP speaker (50). The BGP router reflector may be configured on a network device or computer owned by the ISP, as illustrated in FIG. 2, or on any other convenient network device or computer as discussed above. While a single BGP router reflector may be configured, as illustrated in FIG. 2, additional router reflectors may also be configured to provide redundancy should there be a problem with the primary BGP router reflector or with obtaining access to the primary BGP router reflector.

To manage the VPN services, the service provider generally maintains a centralized VPN management center. The VPN management center generally functions to configure the CE network devices, handle communications between VPN customers and the service provider, monitor the status of the VPN networks, and provide any other services necessary or convenient to the VPN network and customers. Optionally, the BGP router reflector may be collocated with the service provider's VPN management center to facilitate communications between the BGP router reflector and the other devices in the VPN management center, although the invention is not limited in this regard.

Once a router reflector is configured to host BGP peering sessions, a BGP speaker is configured on each of the customer edge network devices (52), and a pair of BGP peers is configured between each of the customer edge network device BGP speakers and the BGP speaker on the BGP router reflector (54). Specifically, when the customer edge network device is first set up, a BGP speaker will be configured on the customer edge network device and a pair of BGP peers will be simultaneously or subsequently configured between the customer edge network device and the BGP speaker associated with the BGP router reflector. The BGP peering session between the CE network device and the BGP router reflector can be set up through a public channel using the CE network device's public IP address, through a secure VPN management channel, or through any other convenient method.

Once the peering session has been set up, the CE network device communicates its site's reachability information (intra-domain network routing information), as well dynamic changes of this information, to the BGP router reflector. In one embodiment, the CE network device collects the intra-domain network routing information from the routing protocol in use on the VPN site. The invention is not limited in this regard, however, as the routing information for the VPN site may be collected or received by the CE network device in any conventional or convenient manner. The CE network device translates this routing information from RIP, OSPF, or IBGP format, into a format acceptable for transmission via the BGP peering session in a conventional manner, and communicates the intra-domain routing information to the central BGP speaker through the BGP peering session that has previously been established (56).

When advertising a route, a customer edge network device attaches the VPN information to the route indicating, if a VPN site belongs to more than one VPN, through which VPN the route can be reached. The VPN information can be identified, for example, using a VPN ID that is used in other types of provider provisioned virtual private networks, or using any other conventional or convenient manner.

Policy information may be used to restrict access to particular routes on the customer side of the BGP peering session, at the BGP router reflector, or both (58). For example, an VPN site may decide to apply policy information to the intra-domain routing information and only advertise the routes to destinations that are to be accessible from outside of the VPN site. In this scenario, the customer edge network device should apply the policies and filter out routes that should not be advertised. Optionally, the policy may be applied by another network device associated with the VPN sites that is configured to provide the CE network device with intra-domain routing information. The remaining routes, in this embodiment, are then sent to the ISP. Alternatively, the information as to which routes should be advertised and which should not be advertised may be communicated to the BGP router reflector, and responsibility for advertising only the correct results will rest at the BGP router reflector. This has the advantage of enabling the BGP router reflector to have a more complete picture of the network as a whole, but has the disadvantage of requiring the VPN site to share routing information which it may prefer to keep secret. Optionally, both types of policy information may be applied.

After intra-domain reachability information has been communicated from the customer edge network device to the service provider, the central BGP speaker distributes the site's reachability information to other appropriate VPN sites (60). Specifically, when the central BGP speaker receives a route from a VPN site, it first processes the route and updates its own database as a normal BGP speaker does. Then the central BGP speaker distributes the route to appropriate VPN sites according to the VPN information in the route and the policy information (as discussed above).

When distributing a route to other customer edge network devices, the central BGP speaker attaches the related VPN tunnel information. The related VPN tunnel information may be considered an equivalent to the Next Hop attribute within a BGP route, which indicates to a VPN site over which tunnel the traffic should be reflected to reach the route. The status of the VPN tunnel will affect the distribution of the routes, as discussed in greater detail below.

After the routes are received by an CE network device from the BGP router reflector, the customer edge network device processes the route as a normal BGP speaker does. Specifically, the CE network device translates the received information from BGP format into a format appropriate for use by the local routing protocol, e.g., RIP, OSPF, or IBGP, and updates its router table with the new information. The CE network device then populates the route within the site through the local routing protocol in a conventional manner.

The BGP router reflector updates and distributes the reachability information whenever a VPN tunnel status changes. Specifically, the service provider's VPN management center usually has the capability of monitoring the status of a site-to-site VPN tunnel. When the status of a VPN tunnel changes, for example if the status of a VPN tunnel changes from up to down, the BGP router reflector is instructed to update affected routes from those sites. If the tunnel is the only tunnel to a site, then all the routes from that site are withdrawn, and the BGP router reflector will notify the affected VPN sites to withdraw those routes. If the tunnel is not the only tunnel to the site, however, the BGP router reflector will attempt to choose an alternative routing path and attach the new VPN tunnel information to the routes and redistribute them to appropriate VPN sites. Likewise, when a VPN member leaves its group, the BGP router reflector will update related routes and communicate with affected sites to enable the affected sites to stop attempting to send data to the site that is leaving the VPN group.

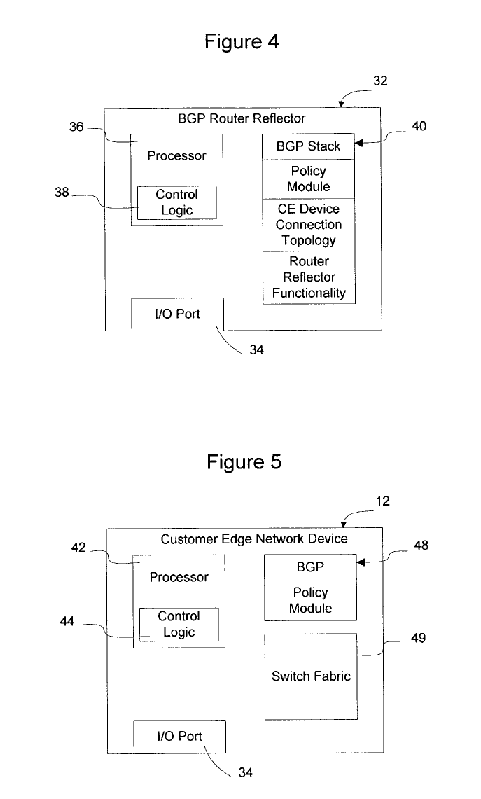

One example of a BGP router reflector 32 according to an embodiment of the invention is illustrated in FIG. 4. As shown in FIG. 4, the BGP router reflector 32 in this embodiment includes an in-out port 34 for receiving and transmitting information to and from the various CE network devices, a processor 36 containing control logic 38 configured to establish, maintain, and terminate BGP peering sessions with the CE network devices, and a memory 40 to hold instructions for execution on the processor. In one embodiment, the BGP router reflector is a personal computer or other processing device capable of processing instructions to implement the functions of the BGP router reflector discussed herein. In another embodiment the BGP router reflector is instantiated as a process on another network device, such as a router or switch, and is established as a process running on the network device's processor. The invention is not limited to a particularly type of processing apparatus or network device.

One or more software processes are instantiated on the BGP router reflector to enable the BGP router reflector to exchange routing information between the customer edge network devices associated with the autonomous systems. One such process is a BGP protocol stack that enables the processor to communicate with the customer edge network devices through the use of the established BGP protocol. The BGP stack provides the BGP router reflector with basic information as to how to communicate with CE network devices and enables the BGP router reflector to communicate using known BGP protocol conventions.

The BGP router reflector also includes a policy module which is a control module that tells the router server how to reflect routes. It enables the router server to discover policy information from the network and CE network devices, as discussed above, and provides the user or the connectivity provider with the ability to discriminate as to which CE network devices should receive routing information from a particular CE network device. The policy module may optionally include VPN configuration information as well.

The BGP router reflector also includes a process containing the CE network device connection topography. The CE network device connection topography enables the BGP router reflector to use information about the overall topography of the virtual private network tunnels to route around failed VPN tunnels. Thus, for example using the network illustrated in FIG. 2 as an example, if the VPN tunnel 24 between CE2 and CE3 fails, the BGP router reflector CE network device connection topology process will use the connection topology information to route packets through VPN tunnel 26 from CE2 to CE1, and then through VPN tunnel 28 between CE1 and CE3 (the reverse order for packets traveling from CE3 to CE2). This enables the BGP router reflector to bypass a failed VPN tunnel and improve resiliency in the network as a whole.

Instructions related to the BGP router reflector are contained in the router reflector functionality module. This module enables the BGP router reflector to function as a conventional router reflector on the network and to receive, store, and distribute routing information to and from the CE network devices.

The BGP router reflector may include additional or alternate components/processes configured to facilitate deployment of the functionality ascribed to it herein. The invention is thus not limited to a router reflector or a system employing a router reflector with only the enumerated components discussed herein, but rather extends to any router reflector performing the functions described herein and as set out in the claims.

A customer edge network device, such as the embodiment illustrated in FIG. 4, is configured to communicate routing or other reachability information via a BGP peering session with a BGP router reflector (see FIG. 3). As shown in FIG. 4, the customer edge network device 12 includes a processor 42 containing control logic 44, an I/O port 46 for communicating with the router reflector 32, and a memory 48 configured to hold instructions for execution on control logic 44. A switch fabric 49 optionally may be provided to handle routing of data packets through the CE network device.

The memory 48 in this embodiment contains at least a BGP stack containing instructions related to the BGP protocol, and instructions related to policies to be applied to routing information. The policy information may be applied to the routing information prior to transmission via the BGP peering session, may be communicated along with the routing information via the BGP peering session, or both.

The control logic 38 of BGP router reflector 32, and control logic 44 of customer edge network device 12, may be implemented as a set of program instructions that are stored in a computer readable memory within the network device and executed on a microprocessor, such as processor 36 or 42. However, in this embodiment as with the previous embodiments, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of exchanging reachability information, the method comprising the steps of:
receiving, by a BGP router reflector, first reachability information, from a first BGP speaker; and
transmitting second reachability information from the BGP router reflector to a second BGP speaker, said second reachability information comprising at least a portion of said first reachability information.

2. The method of claim 1, further comprising the step of receiving, by the BGP router reflector, third reachability information, from a third BGP speaker, and wherein the second reachability information comprises at least a portion of said third reachability information

3. The method of claim 2, wherein the first reachability information is intra-domain routing information for a first VPN site, wherein the third reachability information is intra-domain routing information for a third VPN site, and wherein the first VPN site is distinct from the third VPN site.

4. The method of claim 2, wherein the first BGP speaker is configured on a first network device, wherein the second BGP speaker is configured on a second network device, and wherein the third BGP speaker is configured on a third network device.

5. The method of claim 4, wherein the first network device is on a first VPN site, the second network device is on a second VPN site, the third network device is on a third VPN site.

6. The method of claim 5, wherein the first network device is interconnected with the second network device via a first VPN tunnel, the second network device is interconnected with the third network device via a second VPN tunnel, and the third network device is interconnected with the first network device via a third VPN tunnel.

7. The method of claim 6, further comprising establishing a path between the first network device and the third network device via the first VPN tunnel and the second VPN tunnel.

8. The method of claim 1, wherein the first BGP speaker is configured on a first VPN site, the second BGP speaker is configured on a second VPN site, and wherein the first VPN site and second VPN site are interconnected by a first virtual private network tunnel.

9. The method of claim 8, wherein the virtual private network tunnel is formed by at least one of encapsulation and encryption.

10. The method of claim 1, further comprising the step of applying policy information by the BGP router reflector to the first reachability information prior to transmitting the second reachability information.

11. A router reflector, comprising control logic configured to:
receive first reachability information, from a first BGP speaker; and
transmit second reachability information to a second BGP speaker, said second reachability information comprising at least a portion of said first reachability information.

12. The BGP router reflector of claim 11, wherein the control logic is further configured to receive third reachability information from a third BGP speaker, and wherein the second reachability information comprises at least a portion of said third reachability information

13. The BGP router reflector of claim 12, wherein the first reachability information is intra-domain routing information for a first VPN site, wherein the third reachability information is intra-domain routing information for a third VPN site, and wherein the first VPN site is distinct from the third VPN site.

14. The BGP router reflector of claim 11, wherein the control logic is further configured to establish paths between the networks associated with the BGP speakers via VPN tunnels.

15. The BGP router reflector of claim 11, wherein the control logic is further configured to apply policy information to the first reachability information prior to transmitting the second reachability information.

16. A method of intermediating the exchange of routing information between VPN sites, comprising:
configuring a BGP speaker on a router reflector;
configuring a first BGP speaker on a first VPN site;
configuring a second BGP speaker on a second VPN site;
establishing a first BGP peering session between the first BGP speaker and the BGP speaker on the router reflector; and
establishing a second BGP peering session between the second BGP speaker and the BGP speaker on the router reflector.

17. The method of claim 16, further comprising:
communicating first intra-domain reachability information to the BGP speaker on the router reflector via the first BGP peering session; and
communicating at least a portion of the first intra-domain reachability information to the second BGP speaker via the second BGP peering session.

18. The method of claim 17, further comprising:
communicating second intra-domain reachability information to the BGP speaker on the router reflector via the second BGP peering session; and
communicating at least a portion of the second intra-domain reachability information to the first BGP speaker via the first BGP peering session.

19. The method of claim 16, wherein the first VPN site and the second VPN site are interconnected by a virtual private network tunnel.

20. The method of claim 17, further comprising applying policy information to the intra-domain reachability information.
